(19) United States
(12) Patent Application Publication
(10) Pub. No.: US 2010/0145244 A1
(43) Pub. Date: Jun. 10, 2010

(54) Apparatus for application of trigger point pressure in personal fitness centers and the like before or after exercise

(76) Inventors: Robert Schwartz, Boca Raton, FL (US); Todd A. Wolf, Weston, FL (US)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 12/315,661

(22) Filed: Dec. 8, 2008

(51) Int. Cl. A61H 7/00

(52) U.S. Cl. 601/134

(57) ABSTRACT

An apparatus for the application of trigger point pressure, including a rigid base generally proportioned to the size of a human back; and an array of trigger point probes symmetric about a central vertical plane of said base, the array including at least two of an upper neck pair of probes, a mid-back and shoulder blade pair of probes, a mid back pair of probes, and a lower back pair. A radius of curvature of a top of each probe is proportioned for optimal physiologic communication with a trigger point of a contracted muscle.

### FIELD OF THE INVENTION

The invention relates to a device based upon principles of trigger point therapy, particularly adapted for utility in physical fitness centers.

### BACKGROUND OF THE INVENTION

The present invention addresses the need for an effective, convenient and affordable trigger point therapy article useful particularly in physical fitness centers during periods prior to or after a workout. In other words, use to contribute to the process of loosening up or stretching before exercise as well as to minimize the formation of troublesome muscle knots, aches or the like before or following a period of exercise.

So-called trigger point or referred pain is generally the result of contracted knots in muscle tissue, known as trigger points. A trigger point is a small contraction in muscle fiber which, to the finger tips, feels like a small bump or lump and can range in size from a pin head to that of a walnut. Trigger point contraction affects muscles by keeping them tight and weak and often by generating referred pain to nearby areas. This occurs because a muscle which is too tight causes a constant tension upon muscle fibers which, in turn, produce symptoms in adjacent joints, ligaments or other tissue. Results thereof may be limitations in range of motion of the muscle as well as compression of blood vessels and nerves, this causing such symptoms as headaches, neck pain, upper and lower back pain, and other symptoms which are often erroneously ascribed to arthritis, tendonitis, bursitis, or ligament injury.

The prior art, as exemplified by U.S. Application Publication US2008/0139981 (2008) to Walquist et al, entitled Trigger Point Therapy Device, teaches that self-applied trigger point therapy can be effective and can accomplish at least three benefits, namely, breaking into the chemical and neurological feedback loop that maintains proper muscle contraction; increasing circulation that has been restricted by contracted tissue; and directly stretching knotted muscle fibers of the trigger point itself. It is noted that the structure of Walquist does not afford the strength, stability, or safety of use necessary in a fitness center environment.

Self-treatment of trigger point issues is often preferable to professional therapy if a condition can be addressed before it becomes too severe. The consequences of non-treatment can be highly adverse and can include the need for pain medication, surgery, electrotherapy, injections, chiropractic treatment, and acupuncture procedures.

The present invention addresses self-therapy, however through the use of a relatively simple mechanical device in the nature of a rigid board which is attached to a wall. In a preferred use, this wall is located within a physical fitness facility so that it may be used for both preventative and therapeutic purposes. The use of the inventive device however is not limited to health spa facilities. Further, the inventive device, unlike prior art such as Walquist, does not require continual repositioning or selection of a trigger point probe by the end user. Examples of devices in the art which exhibit this same limitation include UK Published Patent Specification No. 1,410,944 (1975) to Lloyd, entitled Massage Board; and WIPO Publication WO 02/05742 A1 (2002) to Campbell, entitled Apparatus For Massaging A Human Body. Other prior art which requires continual repositioning of an acupressure, trigger point or massage probe are U.S. Pat. No. 4,452,237 (1984) to Lewis, entitled Self Acupressure Apparatus; U.S. Application Publication US 2004/0106882 (2004) to Tseng, entitled Kneading Massage Structure; and U.S. Pat. No. 7,320,778 (2008) to Warder, entitled Whole Body Massage Tool Utilizing Gravity For Energy.

Further, none of the above references are practical for purposes of use in a health spa facility because of the personalization of the trigger point probes needed before the device can be used.

Certain therapeutic massage devices for use in conjunction with hydrotherapy are known in the art as, for example, are represented by U.S. Pat. No. 5,899,868 (1999) to VandeBerg, entitled Deep Muscle Knot Relaxing Device and Methods; and U.S. Application Publication U.S. 2004/0078885 (2004) to Walker, entitled Tactile Therapy System For Spas. The latter is more particularly directed to reflexology of the hand or foot in conjunction with hydrotherapy. The probes of VandeBerg are not optimized to address trigger point contraction. Related devices of this character directed to reflexology only are represented by U.S. Pat. No. 4,852,553 (1989) to Voykin.

There exist a small number of prior art devices which employ a board or substrate and with which a self-administered back massage may be effected. These are U.S. Application Publication US 2002/0068888 (2002) to Wang; and U.S. Pat. No. 7,087,004 (2006) to Berke, entitled Self-Administered Back Massage. Both of these devices address only a small area of the back and the probes thereof are not adapted in shape to treat trigger point issues as set forth herein.

While the above reference to VandeBerg relates to deep a muscle knot-relaxing device, the probes thereof are always positioned at a fixed distance relative to each other and, more importantly, are designed to assure that only one probe at a time is employed. In distinction, the present invention is intended to assure that a minimum of two probes at a time, and often several, are operative at the same time. Accordingly, while VandeBerg recognizes the importance of trigger points that exist in a human back, it does not provide a solution practical for use in a physical fitness facility in which only limited time is available to relieve pressure upon many different trigger points. As such, VandeBerg does not recognize that deep muscle fiber spreading to relieve muscle knots at trigger points can be addressed on a multiple location basis to yield both multiple, synergistic and more efficient benefits. The functionality of Vandeberg is also reliant upon its use in association with hydrostatic pressure beneath the base thereof.

The within invention addresses these deficiencies in the prior art.

This and other objects and advantages of the invention will become apparent from the Detailed Description of the Invention that follows:

### SUMMARY OF THE INVENTION

An apparatus for the application of trigger point pressure comprises a rigid base generally proportioned to the size of a human back; and an array of trigger point probes symmetric about a central vertical plane of said base, said array comprising at least two of an upper neck pair of probes, a mid-back and shoulder blade pair of probes, a mid back pair of probes and a lower back pair. A radius of curvature of a top of each probe is proportioned for optimal physiologic communication with a trigger point of a contracted muscle. Multiple groups of probes may be used at the same time.

It is an object of the present invention to provide an apparatus particularly adapted for use in personal fitness centers, to accomplish the application of pressure to muscular knots and the like, clinically known as trigger points.

It is another object to provide an effective, convenient and affordable apparatus for the accomplishment of both trigger point therapy and to assist in loosening-up or stretching before exercise to minimize the potential for the formation of muscle knots or trigger points as a result of exercise.

It is a further object of the invention to provide a device particularly adapted for self-application of muscle knot therapy through the application of cross-fiber friction, clinically known as petrissage.

It is a yet further object to provide an apparatus of the above type particularly adapted to access pressure points by simple vertical and horizontal motion by a user of his back against the inventive apparatus.

A further object of the present invention is to provide apparatus for self application of pressure to multiple groups of trigger points at the same time.

The above and yet other objects and advantages will become apparent from the hereinafter set forth Brief Description of the Drawings, Detailed Description of the Invention and Claims appended herewith.

### BRIEF DESCRIPTION OF THE DRAWINGS

FIG. 1 is a front elevational view of the inventive device.

FIG. 2 is a vertical cross-sectional view taken along Line 2-2 of FIG. 1, showing therein the geometry of the trigger point probes of the invention.

FIG. 3 is a schematic physiologic view of selected trigger points of the upper back and shoulder blade area addressed by the device, as is more fully set forth herein.

FIG. 4 is a schematic physiologic view showing trigger points in the area of shoulder and lower blades, as is more fully set forth herein.

FIG. 5 is a rear physiologic view showing trigger points of the mid and lower back, as is more fully addressed below.

FIG. 6 is a schematic physiologic view of the back showing additional trigger points addressed by the invention.

FIG. 7 is a schematic physiologic view of trigger point contractions within a group of muscle fibers.

FIG. 8 is a schematic view showing the effect of the apex of the frustoconical probe of the invention to apply pressure to a contracted trigger point of within muscle fibers shown in FIG. 7.

FIG. 9 is a front plant view of a further embodiment of the invention.

### DETAILED DESCRIPTION OF THE INVENTION

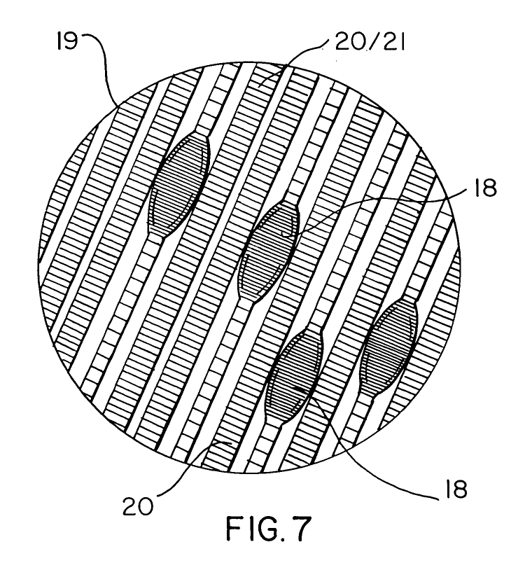

A trigger point 18 within a muscle 19 arises when over-stimulated or extended muscle fibers 20 are unable to release from their contracted state. See FIG. 7. This effect, as above noted, can range in dimension from the size of a pin head to that of a walnut. However, most trigger points exist as small lumps or nodules within the muscle or as groups thereof. A muscle fiber, in its normal resting state, is neither stretched nor contracted and as such defines a relatively linear tissue. See FIG. 7. As is more fully set forth below, certain muscle groups, including groups within the neck and back that are addressed by the present invention, recur as significant areas of trigger point distress. The nodules within muscle fiber defined by trigger points affect not simply the muscle per se but, as well, the means by which the muscle attaches to ligaments or bone. Thereby, the effect of a distressed trigger point is often transmitted to tissue which is some distance away—a phenomenon known as referred pain.

In general, muscle fiber is formed of a vast number of cells 21 known as sarcomeres which act as microscopic pumps, contracting and releasing, to facilitate the circulation of blood through the capillaries to supply their metabolic needs. However, when sarcomeres hold their contraction after a voluntary use of a muscle group has occurred, blood flow essentially stops in that immediate area, the result being oxygen starvation and accumulation of waste products of metabolism which in turn form and irritate the trigger point 18. Trigger point irritation, if untreated, enters an emergency mode by sending out pain signals until the brain institutes an instruction forcing the affected muscle to shut down. This is most typically felt as a shortening or tightening up of the affected muscle. Clearly, it is the interest of everyone, and fitness interested persons in particular, to take reasonable steps to prevent, minimize, or relieve the contraction of the sarcomeres of which all muscle fiber is formed.

Certain muscle groups of the shoulder, neck, upper, mid and lower back are particularly common areas of trigger point irritation.

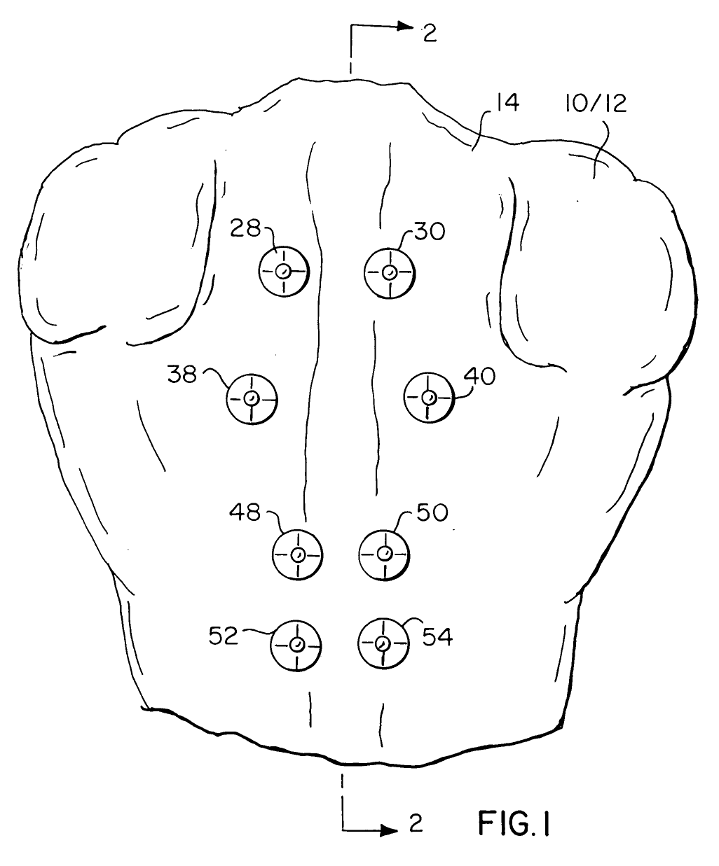

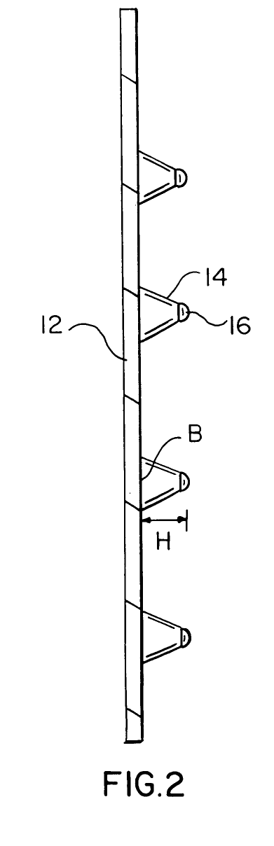

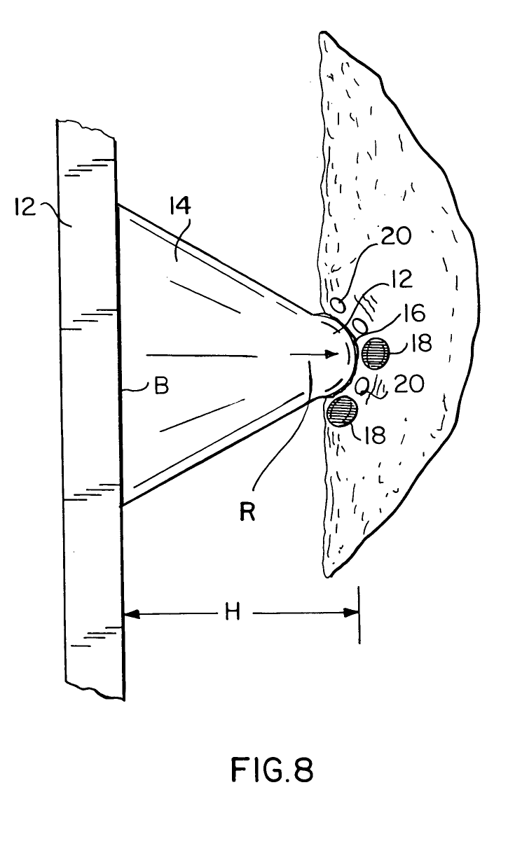

With reference to FIG. 1 may be seen the generalized appearance of the inventive device 10, which includes a base 12, optionally having the appearance of muscles of the back, and a plurality of probes 14 which are preferably integrally formed using a molding process, but which may also be affected by screw-like attachment to a flat base. With reference to FIG. 2, it may be seen that base 12 supports all probes 14 and that each probe defines a height H, a base B, and terminates in a rounded apex 16. The radius R of the apex 16 of each probe (see FIG. 8) must be carefully chosen so that the penetration effected thereby is neither too shallow to accomplish meaningful release of trigger point contraction nor too sharp as to cause injury to the user. As such, a preferred radius R of apex 16 of probe 14 is in the range of 3 to 10 millimeters.

Further shown in FIGS. 7 and 8 is contracted trigger points 18 as well as normal muscle fiber 20 therebetween. See FIG. 7. From FIGS. 7 and 8, it may be appreciated that selection of the proper radius R for the apex 16 of probe 14 is a material consideration in optimizing the function of the inventive device, as is the relation between probe height H and probe base B. Typical values of H and B are in a range of 1.5 to 3.0 cm. Persons not concerned with, or unknowledgeable in regard to, optimizing release of trigger point contraction will typically employ probes having too great a radius. This is reflected in the above cited references to VandeBerg, Wang, Berke and Walquist. Some prior art, such as Lloyd above, teaches the use of massage probes that are pointed, such that their use requires a trained professional.

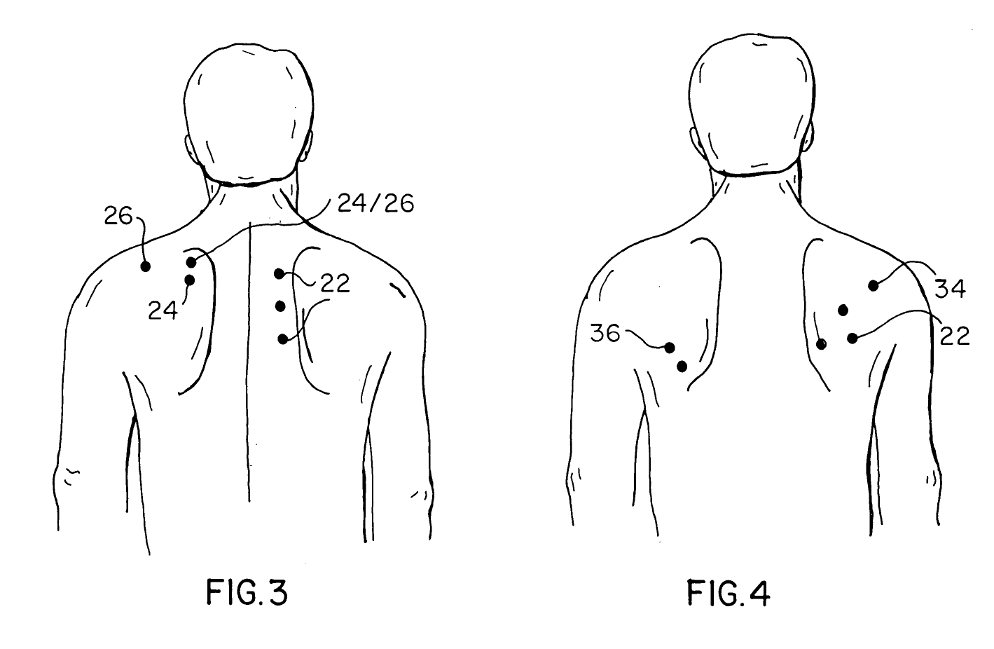

A full understanding of the instant invention requires an appreciation of the trigger points or trigger point groups which are salient in the muscle groups of the human back and which are most commonly sources of stress, strain, or referred pain by body builders and exercise-conscious individuals. More particularly, shown in FIG. 3 are rhomboid trigger points 22 which are located just inward of the shoulder blades. Shown to the left of FIG. 3 are a serratus posterior superior trigger point group 24 and a supraspinatus group 26. As may be noted, the serratus posterior superior group, at its inward portion, approaches the supraspinatus group. These muscle groups are common areas of trigger point pain in that the upper back and shoulders are used in many forms and types of exercise. These muscle groups are specifically accessible by probes 28 and 30 (see FIG. 1) particularly if one positions one's back to optimize contact with the affected muscle groups.

As may be appreciated with reference to FIG. 1, the instant invention provides absolute symmetry between the left and right sides of the device and the probes thereof. As such, even though the physiological illustrations of FIGS. 3-6 show muscle groups on either one or the other side of the back, it is to be understood the muscle groups of the back are completely symmetric thereby, even if a user of the instant device does so because of pain, tightness or the like in a given muscle group on one side of the back, the user may simultaneously effect a preventative treatment of the same muscle group on the opposite side of the back.

In FIG. 4 is shown infraspinatus trigger points 32 and teres minor trigger points 34. The teres major trigger points 36 are shown to the left of FIG. 4. Most of these muscle and trigger point groups may be readily reached by probes 38 and 40 of the device 10 (see FIG. 1), particularly if one moves one's back up and down relative to the base 12 of the device. Accordingly, it is anticipated that users will bend their knees or tilt their body as necessary to optimize contact between given symmetric probes or upper and lower probe groups and trigger points that are a cause of stiffness in a given area or in which the user, based upon personal historic experience, wishes to maximize flexibility of.

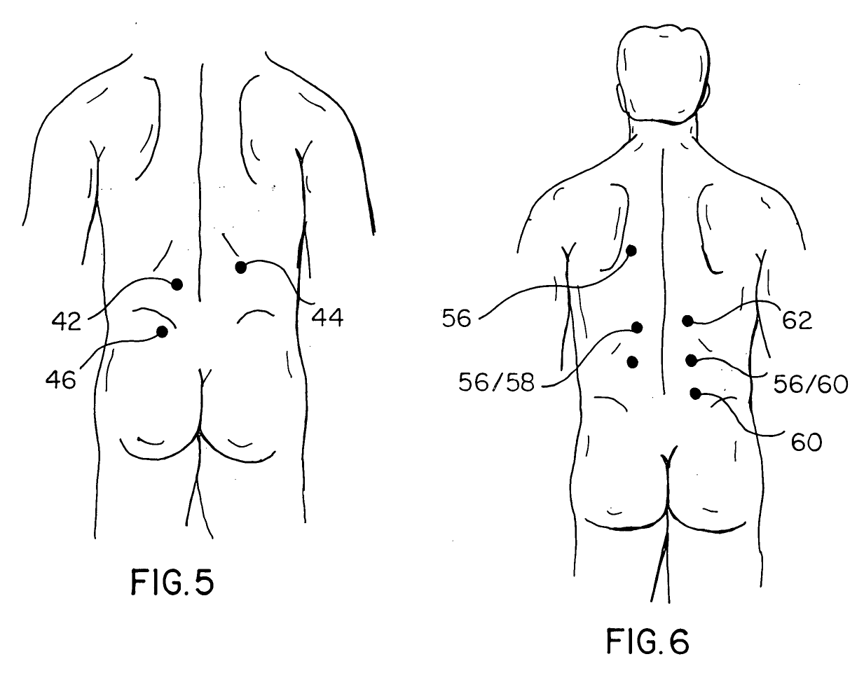

In FIG. 5 are shown lower back trigger points which include trigger point 42 associated with the multifidi muscle trigger point and associated with the levator costae muscle trigger point 44. Also shown is gluteus group 46. These, as are well known to athletes, are common sources of distress. These areas are addressed by probes 48, 50, 52 and 54 (see FIG. 1), understanding that each trigger point group shown in FIG. 5 exists symmetrically upon each side of the back. Accordingly, both the left and right of each trigger point group are concurrently treated by the use of the present device and, as well, one is able to address trigger points of multiple muscle groups at the same time.

In FIG. 6 is shown three somewhat separated trigger point groups 56, all however associated with the iliocostalis muscle group. Trigger point 58 of the serratus posterior anterior trigger point exists near to the middle of the above-referenced iliocostalis group 56. Trigger point 60 relative to the quadratus lumborum muscle is also shown in FIG. 6. Further shown therein is trigger point 62 associated with the serratus posterior anterior muscle. As may be appreciated, all muscle groups shown in FIG. 6 are frequent issues to persons who exercise regularly, particularly in a gym using the array of exercise machinery that is commonly available.

It is further contemplated that the base 12 of the inventive device may be positioned upon a rack having attachment points at various heights, this to accommodate person of different heights. Similarly, the product may be offered in a number of sizes such as small, medium and large including a size particularly adapted to the female anatomy of the back.

With reference to FIG. 8, it is to be appreciated that a squat frustoconical geometry for the probes 14, when molded integrally or properly attached to base 12, is exceedingly stable and possesses a minimum torque arm. I.e., height H including apex 16 has little torque relative to base 12 thereby improving both the stability of the device and its usable lifetime, unlike many of the probes in devices of the prior art which are substantially elongate and, as such, would have a minimal life in a gym or body building environment. As such, and as may be seen in FIGS. 2 and 7, the height H of the probe is generally equal to the diameter B of the base, thus producing a sturdy and durable structure having an extended lifetime, particularly when molded of a properly selected polymer such as polycarbonate.

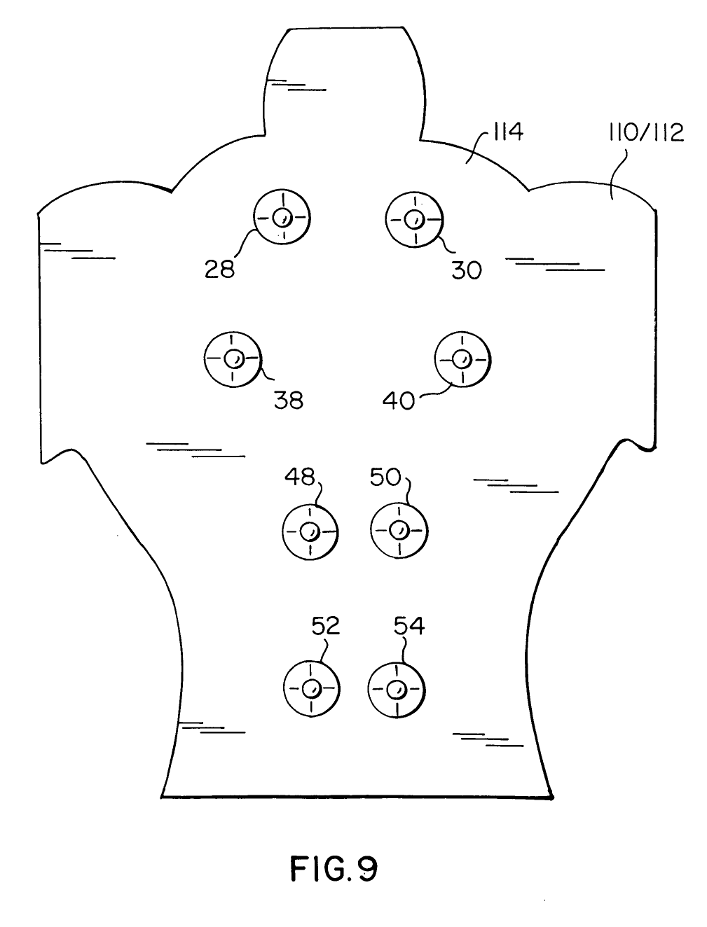

In FIG. 9 is shown a further embodiment 100 of the invention including a flat base 112 and a plurality of probes 44, all of which are similar in geometry and location to above described probes 28, 30, 38, 40, 48, 50, 52 and 54.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. An apparatus for the application of trigger point pressure, comprising:
(a) a rigid base generally proportioned to the size of a human back; and
(b) an array of trigger point probes symmetric about a central vertical plane of said base, said array comprising at least two of an upper neck pair of probes, a mid-back and shoulder blade pair of probes, a mid back pair of probes, and a lower back pair.

2. The apparatus as recited in claim 1, in which a diameter of each of said probes at its base is generally equal to the height thereof.

3. The apparatus as recited in claim 1, in which a radius of curvature of a top of such probe is proportioned for optimal physiologic communication with a trigger point of a contracted muscle.

4. The apparatus as recited in claim 3, in which said radius defines a dimension of between about 2.5 and about 7.5 mm.

5. The apparatus as recited in claim 4 in which said base of said probe defines a dimension of between about 1.5 and about 3.0 cm.

6. The apparatus as recited in claim 5, in which a diameter of each of said probes at its base is generally equal to the height thereof.

7. The apparatus as recited in claim 1, in which said rigid base exhibits the appearance of muscles of the human back.
